(19) United States
(12) Patent Application Publication
(10) Pub. No.: US 2013/0136392 A1
(43) Pub. Date: May 30, 2013

(54) Vertically coupled wavelength tunable photo-detector/optoelectronic devices and systems

(71) Applicant: The Board Of Trustees Of The Leland Stanford Ju, Palo Alto, CA (US)

(72) Inventors: Yijie Huo, Mountain View, CA (US); James S. Harris, JR., Stanford, CA (US); Yiwen Rong, San Mateo, CA (US); Edward Fei, Mento Park, CA (US)

(21) Appl. No.: 13/687,839

(22) Filed: Nov. 28, 2012

Related U.S. Application Data
(60) Provisional application No. 61/629,814, filed on Nov. 28, 2011.

(51) Int. Cl. G02B 6/12

(52) U.S. Cl. CPC G02B 6/12
USPC 385/14

(57) ABSTRACT

A system concept is provided for optical and/or optoelectronic integration that is based on coupling two or more waveguide detectors that are tunable to the same optical waveguide. This common optical waveguide can be regarded as an optical bus. The detectors each have two waveguide ends that are coupled to the optical bus, and light in the detectors that is not absorbed can propagate from the waveguide detectors to the optical bus. A preferred approach for implementing such coupling of detectors to the optical bus is the use of 3-D waveguide tapers between the detectors and the optical bus. Tuning the detectors in such a configuration can provide numerous useful functions.

### CROSS REFERENCE TO RELATED APPLICATIONS

This application claims the benefit of U.S. provisional patent application 61/629,814, filed on Nov. 28, 2011, entitled “Vertically coupled integrated optical and/or optoelectronic devices and wavelength tunable photo-detector”, and hereby incorporated by reference in its entirety.

### FIELD OF THE INVENTION

This invention relates to integration of optical and/or optoelectronic devices.

### BACKGROUND

A wide variety of optical and optoelectronic devices can be fabricated in semiconductor material systems. Accordingly, integration of such optical and optoelectronic devices in semiconductors has been of interest for many years, motivated by the outstanding success of integration of electronic semiconductor devices. However, it remains difficult to provide integration of optical and optoelectronic devices in semiconductors.

To date, no known approach for optical/optoelectronic integration is remotely close to being as successful as the planar integration of electronic semiconductor devices. As a result of this difficulty, system concepts for integrated optical and optoelectronic devices have not been thoroughly explored.

### SUMMARY

In this work, a system concept is provided for optical/optoelectronic integration that is based on coupling two or more waveguide detectors that are tunable to the same optical waveguide. This common optical waveguide can be regarded as an optical bus to distribute information over the whole chip. The optical bus can be integrated with light source, modulator, semiconductor optical amplifier, the detectors and so on. The detectors each have two waveguide ends that are coupled to the optical bus, and light in the detectors that is not absorbed can propagate from the waveguide detectors to the optical bus.

A preferred approach for implementing such coupling of detectors to the optical bus is the use of 3-D waveguide tapers between the detectors and the optical bus.

Tuning the detectors in such a configuration can provide numerous useful functions. For example: detectors can be selectively enabled or disabled; power absorption by the detectors can be adjusted; the detectors can be made selectively responsive to wavelength division multiplexing channels; and the power and/or spectrum of light propagating in the optical bus can be adjusted.

Advantages of the present approach include:

1) Optical to electrical conversion can be performed only where needed, thereby avoiding unnecessary processing.

2) Many detectors can be placed on the same signal bus with equal or desired power in each.

3) The response of a detector can be altered after fabrication by altering an electrical bias of the detector.

### BRIEF DESCRIPTION OF THE DRAWINGS

FIGS. 1a-c show top, cross section and end views of an exemplary embodiment of the invention.

FIG. 2 shows an exemplary layer structure for a tunable detector.

FIGS. 3a-b show optical mode profile in optical bus and SiGe detector region.

FIGS. 4a-f show several images of exemplary fabricated devices.

FIGS. 5a-c show scanning microscopy images of a fabricated 3-D waveguide taper.

FIG. 6a shows measured photocurrent spectra in a tunable waveguide photodetector.

FIG. 6b shows measured photocurrent in a tunable waveguide photodetector at several wavelengths as a function of bias voltage (i.e., tuning).

FIG. 7 shows an example of multiple optical and/or optoelectronic devices all coupled to the same waveguide.

### DETAILED DESCRIPTION

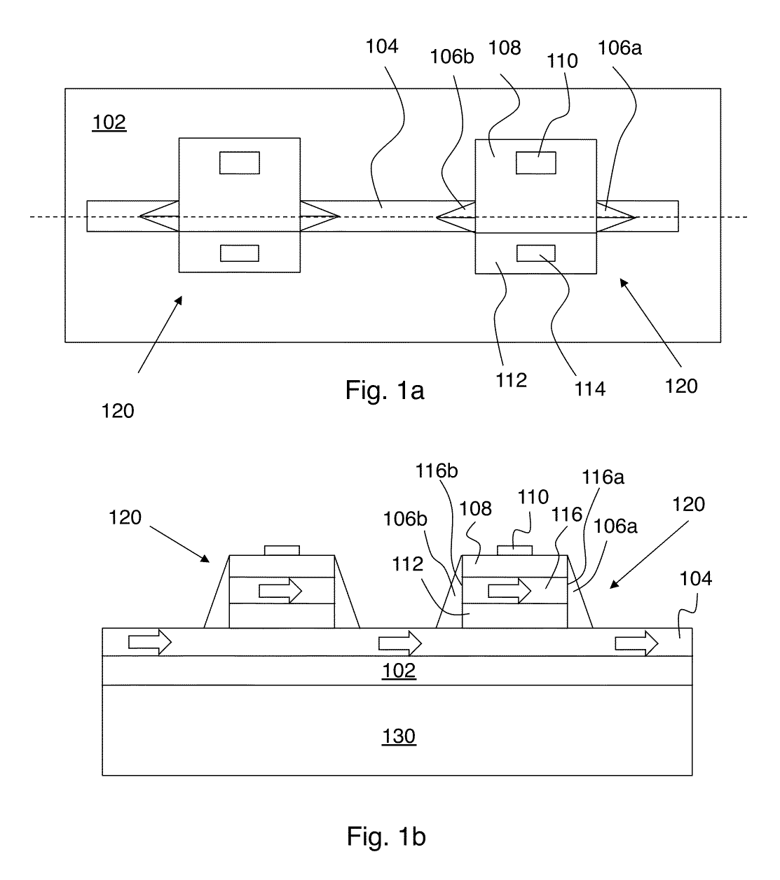

FIGS. 1a-c show several views of an exemplary embodiment of the invention. More specifically, FIG. 1a is a top view, FIG. 1b is a cross section view along the dashed line of FIG. 1a, and FIG. 1c is an end view. In this example, SiGe detectors on a silicon on insulator (SOI) substrate are considered. The SOI substrate includes a silicon substrate 130, a buried oxide layer 102, and a top silicon layer 104. A passive optical waveguide is formed in the top silicon layer 104 to provide an optical bus as described above. Two or more waveguide detectors 120 are coupled to the optical bus. For simplicity, reference numbers for internal features of the detectors are only shown on one of the two detectors depicted.

In this example, this coupling is made using 3-D waveguide tapers 106a, 106b. More specifically, detectors 120 include a p-type SiGe layer 112, an n-type SiGe layer 108, and an intrinsic layer 116 that includes Ge quantum wells (not shown). Contact pads 114 and 110 are disposed on layers 112 and 108, respectively, to provide terminals for the detector. In the detector, intrinsic layer 116 has a higher index of refraction than layers 108 and 112, thereby forming an optical waveguide. Thus, this detector is a waveguide detector having waveguide ends 116a and 116b. These waveguide ends are coupled to the optical bus via the 3-D waveguide tapers 106a and 106b. Thus, light that is not absorbed in a detector can propagate through the detector and be coupled back into the optical bus, as schematically shown by the arrows on FIG. 1b.

Detectors 120 are tunable (i.e., their responsivity vs. wavelength can be adjusted). For example, application of an electrical bias to a quantum well detector (or any detector having quantum-confined structures such as quantum dots, quantum wires, etc. in its active region) can cause a shift of the spectral absorption edge via the quantum-confined Stark effect (QCSE). Such shifting can be static (i.e., applied bias is constant) or dynamic (applied bias changes over time). Further details relating to SiGe optoelectronic devices and the QCSE are given in “Low power SiGe electroabsorption modulators for optical interconnects” by Fei et al. (Proceedings Integrated Photonics Research, Silicon and Nanophotonics (IPRSN), Jun. 17, 2012, Colorado Springs), and “Quantum-confined Stark effect in Ge/SiGe quantum wells on Si” by Rong et al. (J. selected topics in quantum electronics, v16n1, pp 85-91, January 2010), both of which are incorporated by reference in their entirety.

From FIG. 1b, it is apparent that active waveguide sections (i.e., layers 116) and passive waveguide sections (i.e., layer 104) are vertically separated. Such vertical separation is present in preferred embodiments, because it is often necessary for active and passive waveguides to be made in different material systems. Vertical integration of different material systems tends to be easier than lateral integration of different material systems. It is convenient to refer to this integration approach as “vertical coupling”.

Another significant feature of this example is the use of 3-D waveguide tapers 106a and 106b to couple the detectors to the optical bus. This approach is a preferred way to provide the above described vertical separation between active waveguide layers and passive waveguide layers. Such 3-D tapered ends on the vertical device advantageously reduces coupling loss and reflection. An experimental demonstration of this coupling approach is provided below.

Tuning of the detectors in such a configuration can provide various useful functions:

1) Tuning of the detectors can be used to selectively enable or disable the waveguide detectors with respect to light propagating in the optical waveguide.

2) Tuning of the detectors can be used to adjust the spectrum of light propagating in the optical bus.

3) Tuning of the detectors can be used to adjust the power of light propagating in the optical bus. Any combination of power adjustment and spectral adjustment in the optical bus can be provided.

4) Tuning of the detectors can be used to make the waveguide detectors selectively responsive to one or more wavelength division multiplexing (WDM) channels. For example, 4 detectors on a single optical bus could be configures such that WDM channel 1 is only received by detector 1, WDM channel 2 is only received by detector 2, etc. This can be implemented with absorption edge tuning by having the detectors ordered along the optical bus according to their WDM channel wavelength. More specifically, detectors would be ordered such that their WDM channel wavelengths are in sequence from smallest to largest. Thus, the first detector is tuned so that it responds only to the shortest wavelength WDM channel (W1) and absorbs all the energy in W1. The second detector is tuned so that it responds to the W1 channel and to the second-shortest wavelength WDM channel (W2), but it never receives light in the W1 channel because of the first detector. Thus, the second detector only responds to the W2 channel. This approach can be repeated for any number of WDM channels, and avoids the need for separate WDM demultiplexing hardware.

5) Tuning of the detectors can be used to adjust the power absorption by the waveguide detectors. For example, such tuning can be used to implement adjustable electrical power distribution from the optical bus. Such power distribution may be useful in connection with network power distribution (local and/or wide-area networks). Signal power on an optical bus can be dynamically distributed, by using the tunable detector as a tunable attenuator.

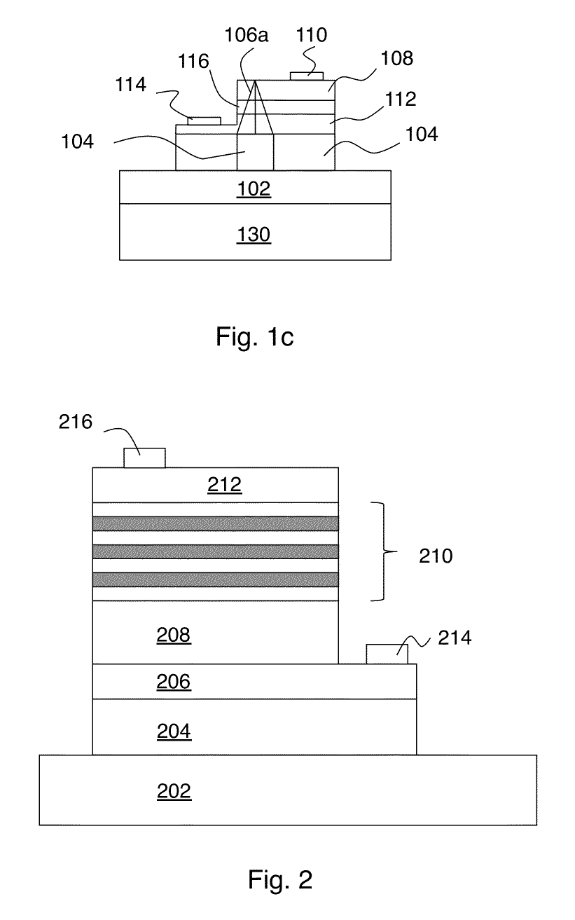

FIG. 2 shows an exemplary layer structure for a tunable detector. In this example, layer 202 is silicon dioxide, layer 204 is 300 nm p-type silicon (passive waveguide layer), layer 206 is 100 nm of p-type Si_{0.12}Ge_{0.88}, layer 208 is 200 nm of p-type Si_{0.12}Ge_{0.88}, and region 210 has three 10 nm quantum well Ge layers (shaded) sandwiched between four 17 nm Si_{0.18}Ge_{0.82} barrier layers (un-shaded), for a total region thickness of about 100 nm. Layer 212 is 200 nm of n-type Si_{0.12}Ge_{0.88}. Contacts 214 and 216 are Ti/Pt/Au. Region 210 is the core for the active waveguide structure. Region 210 is intrinsic, and the doped layers (i.e., layers 204, 206, 208, and 212) have around 1e18 cm⁻³ doping levels. This specific layer structure is provided as an example, and numerous variations are also possible (e.g., more, fewer or no quantum wells, different material systems, different doping levels, etc.).

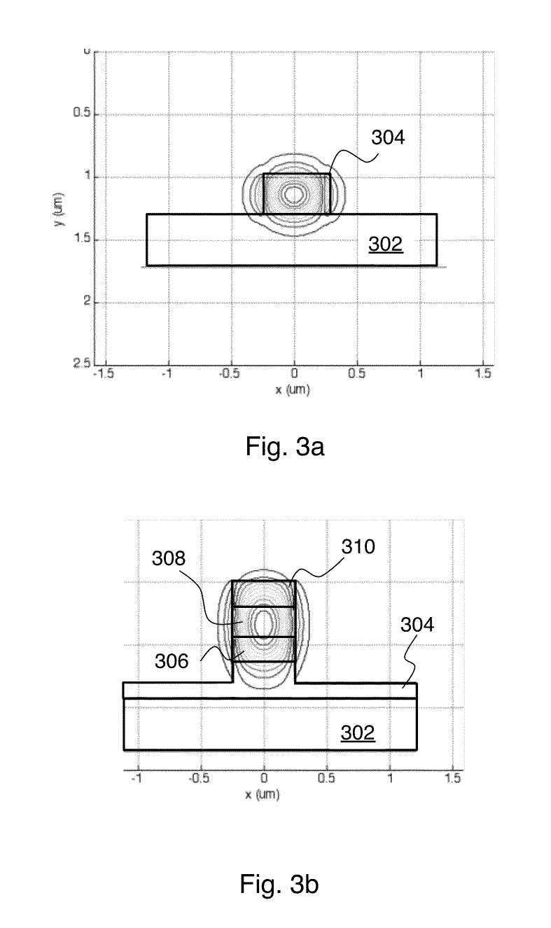

FIGS. 3a-b show modeling results relating to a 3-D waveguide taper. Single mode behavior in the passive waveguide region (FIG. 3a) is seen, with waveguide core 304 (300 nm thick Si) on SiO₂ substrate 302. Single mode behavior is also seen in the active waveguide region (FIG. 3b), with SiO₂ substrate 302, passive Si layer 304 (300 nm thick in ridge), and active waveguide core layer 308 sandwiched between device layers 310 and 306. Layers 306, 308 and 310 are modeled as 600 nm of SiGe (including three Ge quantum wells) in the optical modeling. These results prove the concept of vertical coupling from the passive Si waveguide to the active waveguide in the detector.

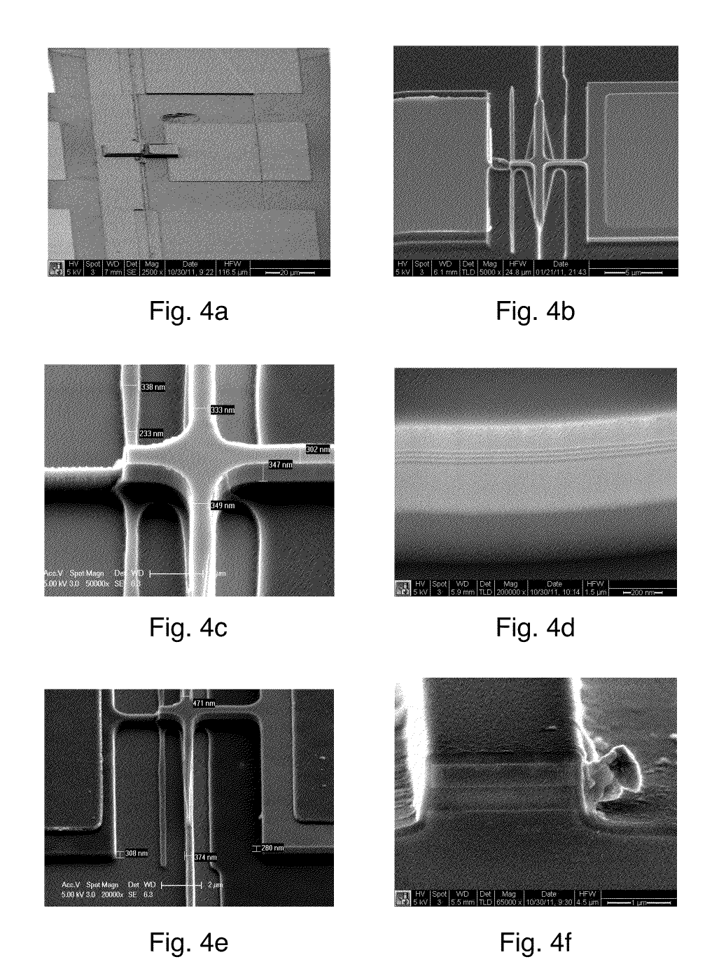

FIGS. 4a-f show several images of exemplary fabricated devices. In general, these devices have the configuration of FIGS. 1a-c, using the specific layer structure of FIG. 2. FIG. 4a is a top overview image (from a 45 degree angle) of a detector integrated with a waveguide. FIG. 4b is a close-up image of a detector integrated with a waveguide. FIG. 4c is a further close-up image of a detector integrated with a waveguide. FIG. 4d is a cross section image showing the quantum wells. FIG. 4e is an image showing the waveguide taper. FIG. 4f is a cross section image of the layer structure in the Si waveguide (300 nm Si on SiO2 on Si substrate. Coated with SiO2 passivation layer.

To fabricate devices as described above, the following exemplary growth and fabrication methods are suitable. The diodes are epitaxially grown on a Si(001) substrate using RPCVD (reduced pressure chemical vapor deposition). To decrease the defect density and surface roughness, the quantum wells are grown on p-type Si_{0.12}Ge_{0.88} buffer layers that undergo a high temperature hydrogen anneal. The active region included three 15 nm quantum wells and a top capping layer of n-type Si_{0.12}Ge_{0.88}.

Using standard optical lithography and projection masks, we first define the waveguide and device pattern in photoresist. Then, plasma etching is used to etch the SiGe. The first mask defines the upper mesa that extends down to the bottom buried oxide layer. The second step defines the devices by etching away the top SiGe layers while leaving the Si waveguide part unetched. The changing of 3D taper width is defined by lithography. The changing of 3D taper thickness is controlled by the etching ratio between photoresist and SiGe layer. Then an oxide insulation layer is deposited using LPCVD (low pressure chemical vapor deposition) to deposit a 30-nm-thick silicon dioxide at 400° C. The next step is contact metallization. We use a metal liftoff approach by first using a mask to deposit photoresist to form a protection layer, and then an E-beam to evaporate the contact metal over the patterned photoresist. Titanium/Pt/Al are deposited. After the evaporation, standard metal liftoff process in an ultrasonic bath is used to remove the resist and excess metal, leaving the desired contact pattern.

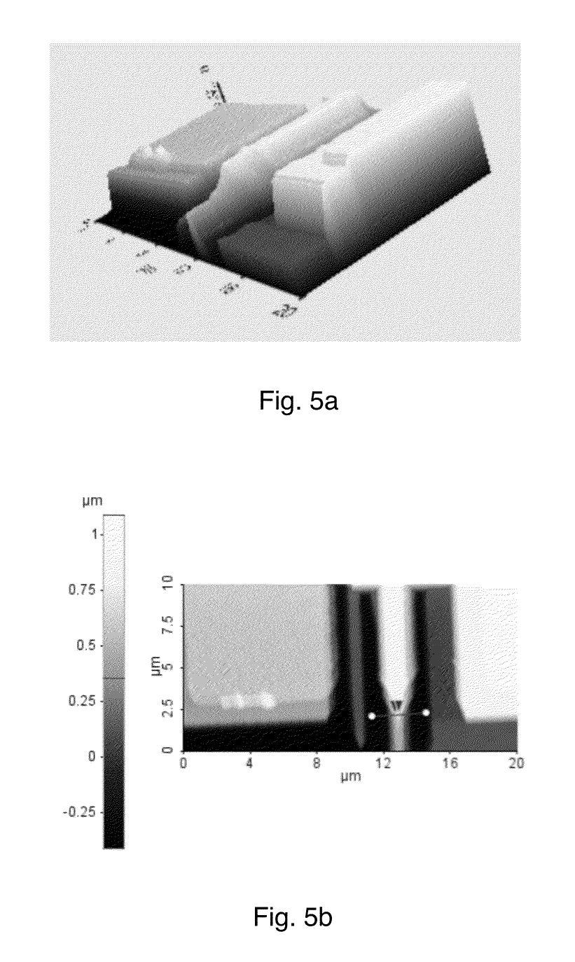

FIGS. 5a-c show scanning microscopy images of a fabricated 3-D waveguide taper. These images demonstrate fabrication of a nearly ideal 3-D waveguide taper structure, which is important for achieving the above-described advantages of vertical coupling. FIG. 5c is a profile scan along the central ridge of FIG. 5a, and demonstrates fabrication of a vertical taper.

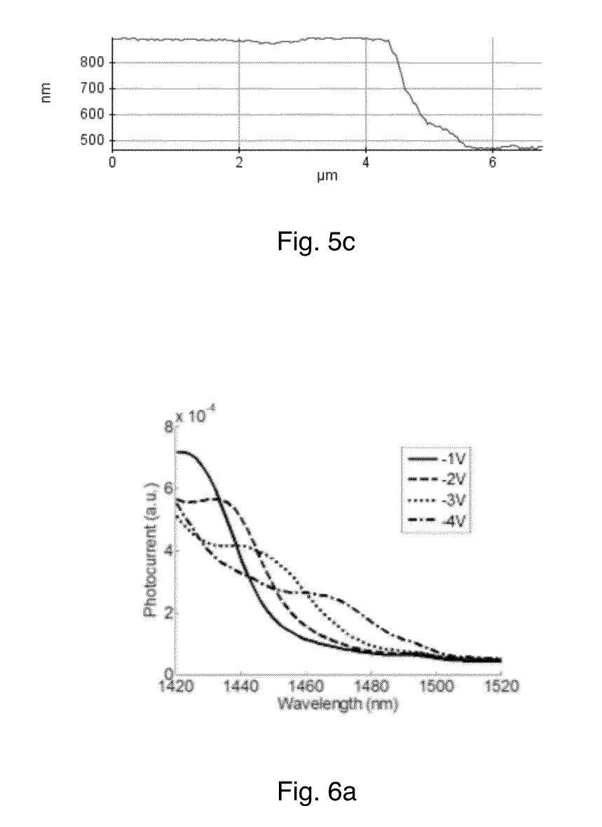

FIG. 6a shows measured photocurrent spectra in a tunable waveguide photodetector. The detector of this experiment was a detector fabricated as described above (i.e., it was vertically coupled using a 3-D waveguide taper). The responsivity spectrum changes significantly with applied voltage, thereby demonstrating tunability of this detector. Furthermore, the absorption edge is advantageously made more sharp than usual because of the QCSE in the detector. For example, at −1V bias, we have 90% absorption at 1431 nm and 50% absorption at 1438 nm, which is a much sharper transition than seen in bulk Ge. We also see device operation controllable over a large wavelength range from 1420-1520 nm, which strongly suggests that such devices can be made C-band capable.

FIG. 6b shows measured photocurrent in a tunable waveguide photodetector at several wavelengths as a function of bias voltage (i.e., tuning). The detector of this experiment was a detector fabricated as described above (i.e., it was vertically coupled using a 3-D waveguide taper). Here it is apparent that the responsivity at a fixed wavelength is a function of applied voltage, thereby providing another demonstration of detector tunability.

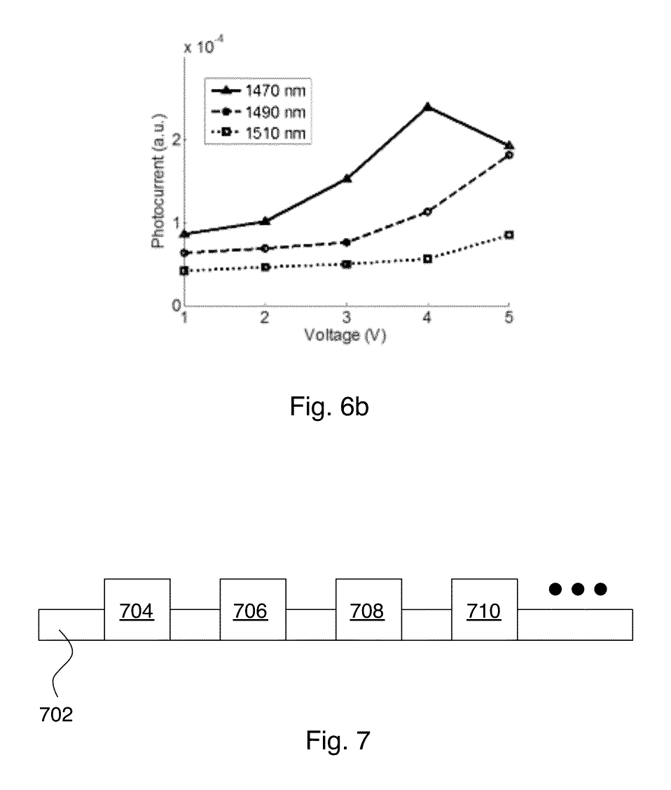

Practice of the invention does not depend critically on material systems, doping levels, etc. Furthermore, any number of additional optical and/or optoelectronic devices can be integrated together with the two or more tunable detectors on the optical bus. Such devices include, but are not limited to: optical sources, light emitting diodes, lasers, optical amplifiers, semiconductor optical amplifiers, optical attenuator, optical modulators, and nonlinear optical devices. FIG. 7 shows an example of multiple optical and/or optoelectronic devices all coupled to the same waveguide. In this example, an optical bus 702 is coupled to devices 704, 706, 708, 710, etc. Two or more of these devices are tunable detectors as described above. The other devices can be any waveguide-coupled optical or optoelectronic device. The optical bus can be part of a photonic integrated circuit disposed on a substrate. Vertical coupling as described above can be employed to couple some, none or all of the additional devices to the optical bus.

1. Apparatus comprising:
an optical waveguide disposed on a substrate; and
two or more waveguide optical detectors, wherein the waveguide optical detectors each have two waveguide ends that are coupled to the optical waveguide, and wherein light in the waveguide detectors that is not absorbed can propagate from the waveguide detectors to the optical waveguide;
wherein the waveguide optical detectors each have a tunable absorption spectrum.

2. The apparatus of claim 1, wherein the substrate has a surface normal that defines a vertical direction, and wherein the waveguide detectors are separated from the optical waveguide in the vertical direction.

3. The apparatus of claim 2, further comprising 3-D waveguide tapers disposed at the waveguide ends of the waveguide detectors.

4. The apparatus of claim 1, wherein the waveguide detectors each have a spectral absorption edge that can be shifted by an applied electrical bias.

5. The apparatus of claim 4, wherein the waveguide detectors include quantum confined structures, and wherein a quantum confined Stark effect contributes to shifting of the spectral absorption edge by the applied electrical bias.

6. The apparatus of claim 1, wherein tuning of the waveguide detectors is used to selectively enable or disable the waveguide detectors with respect to light propagating in the optical waveguide.

7. The apparatus of claim 1, wherein tuning of the waveguide detectors is used to adjust the spectrum of light propagating in the optical waveguide.

8. The apparatus of claim 1, wherein tuning of the waveguide detectors is used to adjust the power of light propagating in the optical waveguide.

9. The apparatus of claim 1, wherein tuning of the waveguide detectors is used to make the waveguide detectors selectively responsive to one or more wavelength division multiplexing (WDM) channels.

10. The apparatus of claim 1, wherein tuning of the waveguide detectors is used to adjust power absorption by the waveguide detectors.

11. The apparatus of claim 1, further comprising one or more devices coupled to the optical waveguide and selected from the group consisting of: optical sources, lasers, light emitting diodes, optical amplifiers, semiconductor optical amplifiers, optical attenuators, optical modulators, and nonlinear optical devices.

12. The apparatus of claim 1, wherein the optical waveguide is part of a photonic integrated circuit disposed on the substrate.
